(19) United States
(12) Patent Application Publication
(10) Pub. No.: US 2024/0261998 A1
(43) Pub. Date: Aug. 8, 2024

(54) ADJUSTABLE BOARD CUTTING APPARATUS, ADJUSTABLE BLADE MOUNT, AND CORRESPONDING METHOD

(71) Applicant: TECHNOLOGIES HUMACO INC., Levis (CA)

(72) Inventors: Maxime Dallaire, Levis (CA); Charles-Olivier Boiteau, Quebec (CA); Jeremy Marcoux, Saint-Apollinaire (CA); Antoine Limoges, Quebec (CA); Pierre-Louis Pruneau, Beauceville (CA); Christophe Landry, Quebec (CA)

(21) Appl. No.: 18/431,534

(22) Filed: Feb. 2, 2024

Related U.S. Application Data
(60) Provisional application No. 63/483,040, filed on Feb. 3, 2023.

(51) Int. Cl. B27B 5/075; B27B 5/34

(52) U.S. Cl. CPC B27B 5/075; B27B 5/34

(57) ABSTRACT

An apparatus for cutting a plate-shaped article into slats includes a housing having a plate-shaped article entrance for receiving the article to be cut into slats, an exit from which the slats are expelled, and a conveying path extending between the article entrance and exit. A cutting device mounted in the housing across the conveying path and which includes a rotating shaft rotatably mounted in the housing, at least one circular blade mounted to the shaft, an adjustable blade mount for each one of the at least one circular blade, mounted to the shaft so as to be translatable and adjustable along the shaft, and a motor operatively connected to the rotating shaft to drive the rotating shaft. A method for cutting a plate-shaped article into slats having predetermined widths is also provided.

### CROSS-REFERENCE TO RELATED APPLICATION

The present application claims priority from U.S. provisional patent application Ser. No. 63/483,040, filed on Feb. 3, 2023, and entitled “ADJUSTABLE APPARATUS FOR CUTTING PLATE-SHAPED ARTICLES,” the disclosure of which being hereby incorporated by reference in its entirety.

### TECHNICAL FIELD

The present disclosure generally relates to board cutting apparatuses for cutting plate-shaped articles, for example drywall and gypsum boards, into slats of a selected dimension, such as width. It also relates to a method for cutting plate-shaped articles, for example gypsum boards, into slats of a selected dimension.

### BACKGROUND OF THE DISCLOSURE

Several types of devices exist in the prior art for cutting plate-shaped articles, for instance boards or sheets of material. These systems are sometimes used as part of a continuous factory line configured to cut a manufactured board into shorter boards of an appropriate length to be delivered to sites where the product may be further processed to serve a customer's specific needs. Other systems exist on a smaller scale to allow end users to arrange plate-shaped articles into the dimensions of their choosing. The most common ways used by the end users to cut and size these boards, such as gypsum boards, is simply the use of different types of saws such as table saws, circular saws and even an “exacto” knife (e.g., X-Acto™)

It is understood that many reasons can lead to configuring a plate-shaped product, whether in construction, art, design, and manufacturing. For instance, in the sectors of construction and renovation, boards of construction material, such as gypsum, plywood, glass and ceramic are routinely manipulated to finish and/or cover structural elements. As such, larger articles of material can be purchased from a manufacturer or retailer to subsequently carve out slats of appropriate dimensions as required onsite. In some cases, these tasks must be repeated, and can consume a significant amount of time.

Already known in the prior art are tools designed to assist in cutting substantially flat articles of a certain material into a desired shaped and, more particularly slats of selected width(s). Some devices are designed to be used by hand. Even if accurate, these devices are generally slower in comparison to specially purposed machines. There is still a need for improved cutting apparatuses, which can quickly and accurately cut plate-shaped articles into slats of a desired dimension, such as the slat width.

### BRIEF SUMMARY

It is therefore an aim of the present disclosure to at least partially satisfy the above-mentioned need.

More particularly, a cutting apparatus and a blade mounting system, all of which satisfy the above-mentioned need, are provided.

According to a general aspect, there is provided an apparatus for cutting a plate-shaped article into slats. The apparatus comprises: a housing and a cutting device. The housing includes a plate-shaped article entrance, a slat exit; and a conveying path extending between the plate-shaped article entrance and the slat exit. The cutting device is at least partially located in the housing across the conveying path. The cutting device comprises: a rotating shaft; at least one adjustable blade mount mounted to the rotating shaft and configured to be displaceable along the rotating shaft; and at least one circular blade secured to a respective one of the at least one adjustable blade mount and being engaged in rotation with the rotating shaft.

In an embodiment, the cutting device further comprises a worktable extending upstream of the plate-shaped article entrance of the housing and configured to support the plate-shaped article as it is received in the housing via the plate-shaped article entrance.

In an embodiment, the housing further comprises a lip adjacent to the plate-shaped article entrance and extending substantially parallel to the worktable and vertically spaced-apart therefrom, the lip being configured to stabilize the plate-shaped article during introduction of the plate-shaped article into the housing.

In an embodiment, the cutting device comprises an additional rotating shaft, a motor and a gear assembly. The additional rotating shaft is mounted in a spaced apart and parallel configuration with the rotating shaft with a section of the conveying path extending inbetween. The motor is operatively connected to the rotating shaft and the additional rotating shaft. The gear assembly mechanically connects together the rotating shaft and the additional rotating shaft to rotate in opposing rotational directions whereby when the plate-shaped article reaches the cutting device, the plate-shaped article is automatically entrained between the rotating shaft and the additional rotating shaft to be cut into slats.

In an embodiment, each one of the at least one circular blade comprises a first half-disc and a second half-disc. Each one of the at least one adjustable blade mount comprises: a first half collar and a second half collar. Each one of the first and second half collars comprises an inner portion engageable with the rotating shaft and a support plate protruding outwardly from and extending perpendicularly to a longitudinal axis of the rotating shaft when mounted thereto. The cutting device further comprises mechanical fasteners engageable with a respective one of the first and second half-discs and a respective one of the first and second half collars to secure the first and second half-discs to the respective one of the first and second half collars.

In an embodiment, the at least one adjustable blade mount further comprises a shaft locking assembly for detachably securing the first and second half collars at a selected longitudinal position along the rotating shaft.

In an embodiment, the apparatus further comprises a carrier on which the housing is mountable for carrying and displacing the apparatus.

In an embodiment, the carrier comprises one or more framing structures for surrounding at least partially the housing and the cutting device and protecting same.

According to another general embodiment, there is provided an adjustable blade mount for a rotating shaft of a board cutting apparatus. The board cutting apparatus comprises: a first half collar and a second half collar engageable with the rotating shaft of the board cutting apparatus and mechanical fasteners. Each one of the first and second half collars includes an inner portion superposable against the rotating shaft and a support plate protruding outwardly from the inner portion and extending perpendicularly to a longitudinal axis of the rotating shaft when mounted thereto. Each support plate having a cutting blade-receiving face adapted to support at least a portion of a circular cutting blade having respective first and second half-discs. The mechanical fasteners being engageable with a respective one of the first and second half-discs and the cutting blade-receiving face of the support plate of a respective one of the first and second half collars to secure the first and second half-discs to the respective one of the first and second half collars.

In an embodiment, the adjustable blade mount further comprises a shaft locking assembly for detachably securing the first and second half collars at a selected longitudinal position along the rotating shaft.

According to still another general aspect, there is provided a board cutting apparatus for cutting a plate-shaped article into slats. The board cutting apparatus comprises: a housing, a cutting device and at least one cutting blade assembly. The housing defines a plate-shaped article entrance for receiving the plate-shaped article, a slat exit opposite of the plate-shaped article entrance to expel the slats, and a conveying path extending between the plate-shaped article entrance and the slat exit. The cutting device includes at least one rotating shaft at least partially located in the housing and across the conveying path. The at least one cutting blade assembly is mounted to the at least one rotating shaft, engageable in rotation therewith, and securable thereto in at least two longitudinally spaced-apart positions.

In an embodiment, each one of the at least one cutting blade assembly comprises at least one adjustable blade mount and at least one circular blade. The at least one adjustable blade mount is detachably securable to the at least one rotating shaft and configured to be displaceable along the least one rotating shaft. The at least one circular blade is detachably secured to a respective one of the at least one adjustable blade mount and being engaged in rotation with the at least one rotating shaft when the at least one blade mount is secured thereto.

In an embodiment, the board cutting apparatus further comprises a worktable extending upstream of the plate-shaped article entrance of the housing and configured to support the plate-shaped article as it is received in the housing via the plate-shaped article entrance.

In an embodiment, the housing further comprises a lip adjacent to the plate-shaped article entrance and extending substantially parallel to the worktable and vertically spaced-apart therefrom, the lip being configured to stabilize the plate-shaped article during introduction of the plate-shaped article into the housing.

In an embodiment, the boarding cutting device comprises: an additional rotating shaft, a motor and gear assembly. The additional rotating shaft is mounted in a spaced apart and parallel configuration with the rotating shaft with a section of the conveying path extending inbetween. The motor is operatively connected to the rotating shaft and the additional rotating shaft. The gear assembly mechanically connects together the rotating shaft and the additional rotating shaft to rotate in opposing rotational directions whereby when the plate-shaped article reaches the cutting device, the plate-shaped article is automatically entrained between the rotating shaft and the additional rotating shaft to be cut into slats.

In an embodiment, each one of the at least one circular blade comprises a first half-disc and a second half-disc. Each one of the at least one adjustable blade mount comprises: a first half collar and a second half collar. Each one of the first and second half collars comprises an inner portion engageable with the rotating shaft and a support plate protruding outwardly from and extending perpendicularly to a longitudinal axis of the rotating shaft when mounted thereto. The at least one cutting blade assembly further comprises mechanical fasteners engageable with a respective one of the first and second half-discs and a respective one of the first and second half collars to secure the first and second half-discs to the respective one of the first and second half collars.

According to yet another general aspect, there is provided a method for cutting a plate-shaped article into slats having predetermined widths. The method comprises: adjusting a longitudinal position of at least one cutting blade assembly along a rotating shaft of a cutting device in accordance with the predetermined width of the slats; securing the at least one cutting blade assembly at the longitudinal position; engaging the rotating shaft having the at least one cutting blade assembly secured thereto in rotation; and translating the plate-shaped article along a conveying path to engage the at least one cutting blade assembly and be cut into the predetermined width slats.

In an embodiment, the at least one cutting blade assembly comprises at least two cutting blade assemblies, and wherein the adjusting of the respective longitudinal position of the at least one cutting blade along the rotating shaft in accordance with the predetermined width of the slats further comprises distributing the at least two cutting blade assemblies according to an irregular configuration wherein a distance between adjacent ones the at least two cutting blade assemblies is variable.

In an embodiment, the method further comprises at least one of adding and removing a respective one of the at least two cutting blade assemblies to the rotating shaft.

In an embodiment, the adjusting of the respective longitudinal position of the at least one cutting blade assembly along the rotating shaft in accordance with the predetermined width of the slats further comprises selectively untightening a shaft locking assembly of the at least one cutting blade assembly and sliding the at least one cutting blade assembly along the rotating shaft, and wherein securing the at least one cutting blade assembly at the longitudinal position comprises tightening the shaft locking assembly of the at least one cutting blade assembly with the rotating shaft.

### BRIEF DESCRIPTION OF THE DRAWINGS

These and other features, aspects and advantages of the present invention will become better understood with regard to the following description, and accompanying drawings where:

FIG. 1 is a front perspective view of an adjustable board cutting apparatus for cutting a plate-shaped article (or board) in accordance with an embodiment;

FIG. 2 is a top plan view of the board cutting apparatus shown in FIG. 1, with a worktable removed;

FIG. 3 is another perspective view of the board cutting apparatus shown in FIGS. 1 and 2, viewed from the top right side, showing one mode of operation, with a plate-shaped article being received in the board cutting apparatus and cut into a plurality of slats;

FIG. 4 is a front perspective view of a carrier, in accordance with an embodiment;

FIG. 5a is a front elevation view of the board cutting apparatus shown in FIG. 1;

FIG. 5b is a sectional view of the board cutting apparatus taken along cross-section line A-A of FIG. 5a;

FIG. 6 is a perspective view of a right-side portion of the board cutting apparatus shown in FIG. 1, showing a gearing coupled to rotating shafts;

FIG. 7 is a front elevation view of a circular blade in accordance with an embodiment;

FIG. 8 is an exploded front elevation view of a two-piece collar, in accordance with an embodiment;

FIG. 9 is an exploded side elevation view of the two-piece collar shown in FIG. 8;

FIG. 10 is an exploded bottom elevation view of the two-piece collar shown in FIG. 8;

FIG. 11a is a side elevation view of a rotating shaft in accordance with an embodiment, with a locking groove to receive detachable locking means; and

FIG. 11b is a sectional view of the rotating shaft taken along cross-section line B-B of FIG. 11a.

It will be noted that throughout the appended drawings, like features are identified by reference numerals.

### DETAILED DESCRIPTION

In the following description, non-limitative embodiments of the adjustable apparatus for cutting a plate-shaped article are described. Although these embodiments of the apparatus and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the apparatus, as will be briefly explained herein and as can be easily inferred herefrom by a person skilled in the art. Moreover, it will be appreciated that positional descriptions such as “above,” “below,” “left,” “right” and the like should, unless otherwise indicated, be taken in the context of the figures and should not be considered limiting.

Furthermore, in the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only.

In the following description, an embodiment is an example or implementation. The various appearances of “one embodiment,” “an embodiment” or “some embodiments” do not necessarily all refer to the same embodiments. Although various features may be described in the context of a single embodiment, the features may also be provided separately or in any suitable combination. Conversely, although the invention may be described herein in the context of separate embodiments for clarity, it may also be implemented in a single embodiment. Reference in the specification to “some embodiments,” “an embodiment,” “one embodiment” or “other embodiments” means that a particular feature, structure, or characteristic described in connection with the embodiments is included in at least some embodiments, but not necessarily all embodiments.

It is to be understood that the phraseology and terminology employed herein are not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above. It is to be understood that the terms “including,” “comprising,” and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not to be construed that there is only one of that element. It is to be understood that where the specification states that a component, feature, structure, or characteristic “may,” “might,” “can” or “could” be included, that particular component, feature, structure, or characteristic is not required to be included.

### Adjustable Apparatus for Cutting Plate-Shaped Articles

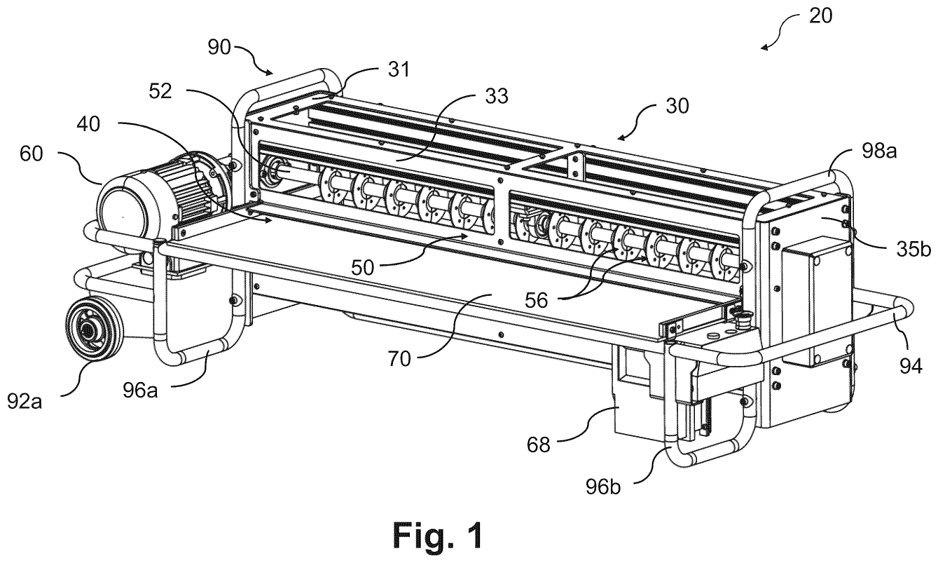

Referring now to the drawings, and more particularly to the embodiment shown in FIGS. 1 to 3, an adjustable board cutting apparatus 20 is used to cut a plate-shaped article 10 into at least two parallel and longitudinally-extending slats 12. The board cutting apparatus 20 includes a housing 30, a cutting device 50 with at least one circular blade assembly 56 to cut the plate-shaped article 10, and a worktable 70 mounted upstream the cutting device 50. In the embodiment shown, the cutting device 50 of the board cutting apparatus 20 includes a motor 60 operatively connected to the cutting device 50.

It will be noted that the “plate-shaped article” 10 (i.e., the article 10) can be understood as any article having compatible characteristics (e.g., dimensions and material composition) with the specifications of the board cutting apparatus 20. The term “plate-shaped” designates an article with a substantially flat structure and, more particularly a board. A non-limiting list of plate-shaped article 10 contemplated in this disclosure includes a sheet of drywall/gypsum, a board of plywood, a plate of aluminum. In other words, the apparatus disclosed is designed to cut an array of articles, only some of which are described hereunder, but additional uses are envisioned.

It will also be noted that for the purpose of this disclosure, a “slat” 12 can be understood as an elongated portion having been sectioned (i.e., cut) from the plate-shaped article 10 by the board cutting apparatus 20. Finally, it is understood that the number of slats 12 produced depends on the number of circular blade assemblies 56 being configured in the cutting device 50.

For the sake of simplicity, the rest of the disclosure will refer to a singular circular blade assembly 56, even if a plurality of blade assemblies 56 can be envisioned fora given embodiment, as will be explained in more detail below.

### Housing

The housing 30 includes a plate-shaped article entrance 40 (i.e., an entry slot, or entry) through which the plate-shaped article 10 is received, a slat exit 42 from which the slats 12 are ejected or expelled from the housing 30 to be collected thereafter and a conveying path 44 extending between the plate-shaped article entrance 40 and the slat exit 42, on which the article 10 is conveyed to be cut into longitudinally-extending slats 12 by the cutting device 50 described in more detail below.

Referring to the embodiment of the housing 30 illustrated in FIGS. 1, 3 and 5b, the housing 30 can include a top wall 31, a front wall 33, a rear wall, and two side walls 35a, 35b. In the embodiment shown, the article entrance 40 is defined in the front wall 33 of the housing (in a lower portion thereof) (or below the front wall 33 of the housing 30), and the slat exit 42 is defined in the rear wall section (not visible in the figures) (or below the rear wall of the housing 30). It is to be noted that the shape and the configuration of the housing 30 can vary from the embodiment shown. Furthermore, the shape, the configuration, and the locations of the article entrance 40 and the slat exit 42 can vary from the embodiment shown.

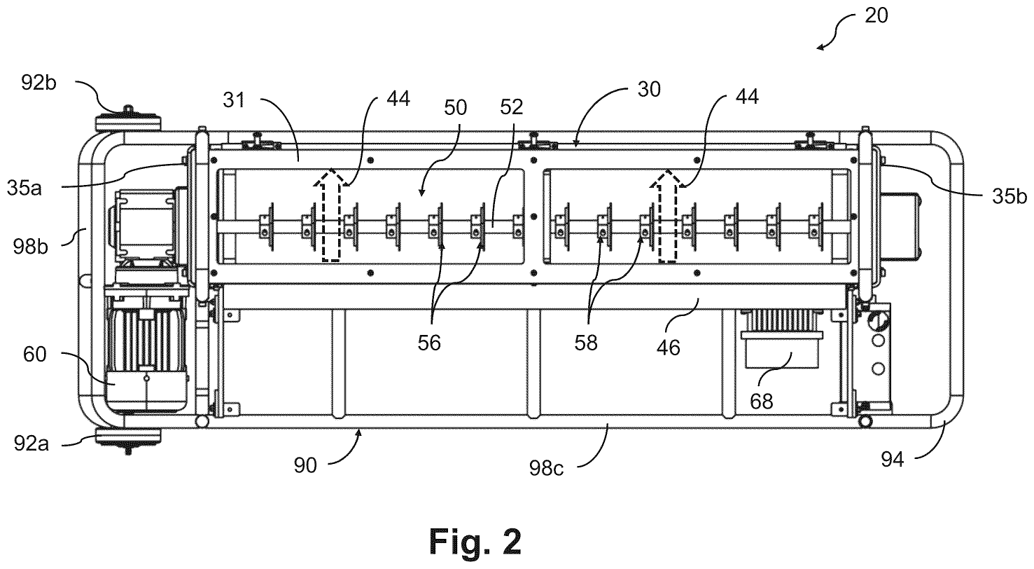

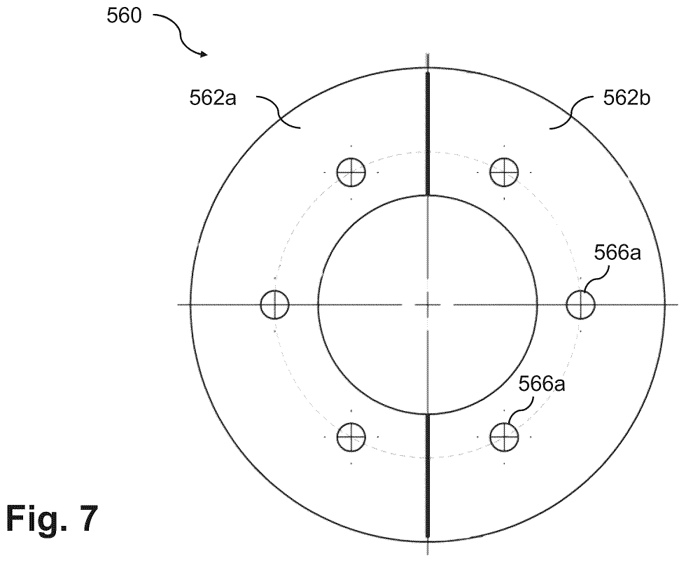

It is to be noted that the conveying path 44 (represented by a hollow and dotted arrow in FIGS. 2, 3 and 5b) represents the normal path of motion of the plate-shaped article 10 as it is being transported or conveyed throughout the cutting device 50 from the article entrance 40 to the slat exit 42 of the housing 30. In other words, the conveying path 44 can be understood as a horizontal plane levelled with the article entrance 40 of the housing 30 such that the plane of the conveying path 44 encounters circular blades 560 (FIG. 7) of the blades assemblies 56 of the cutting device 50 (or a single circular blade 560), and extends from the article entrance 40 to the slat exit 42. The terms “upstream” and “downstream” are used in the context of the conveying path 44.

It is to be noted that one function of the housing 30 is to prevent unintended foreign objects from accidentally interacting with or being ejected from the cutting device 50. As such, the housing 30 can prevent jamming or damage to the cutting device 50, safeguard the operator (or any other individual) from accidental contact with the cutting device 50, and shield the operator from debris that may be ejected as a result of the relatively high-speed sawing operation in the conveying path 44.

It is to be noted that the expressions “in operation,” “during operation” and “mode of operation” are to be understood as the period during which a plate-shaped article 10 is being cut (or is about to be cut) by the cutting device 50 of the board cutting apparatus 20.

As shown in the embodiments of FIGS. 1 to 3 and 6, for ease of operation of the board cutting apparatus 20, it will be appreciated that the top, front 31, 33 and rear wall sections of the housing 30 can be made at least partially of glass, or other transparent materials, to provide an operator with a clear line of sight of the conveying path 44 and/or the cutting device 50. In the non-limitative embodiment shown, the housing 30 comprises a metal frame supporting transparent panels.

### Worktable

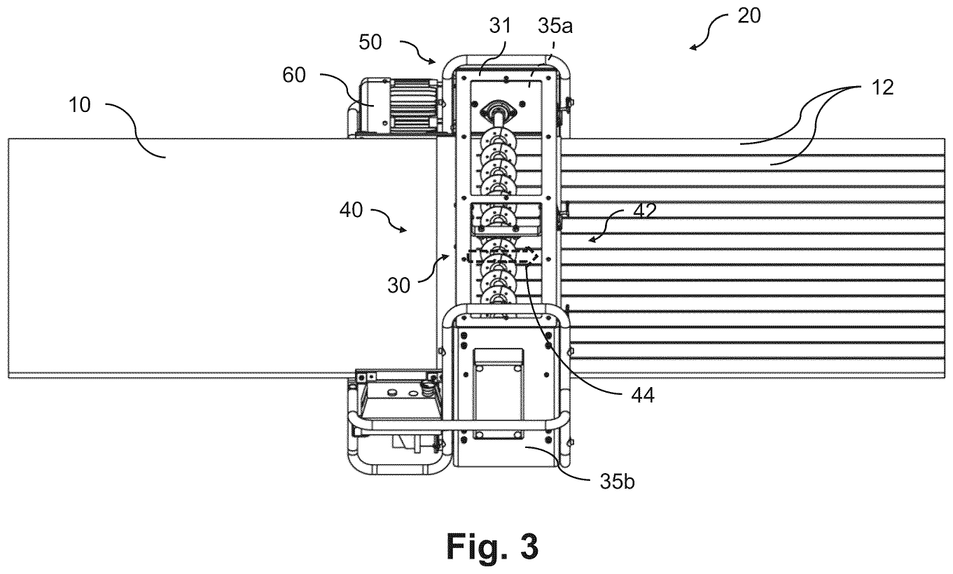

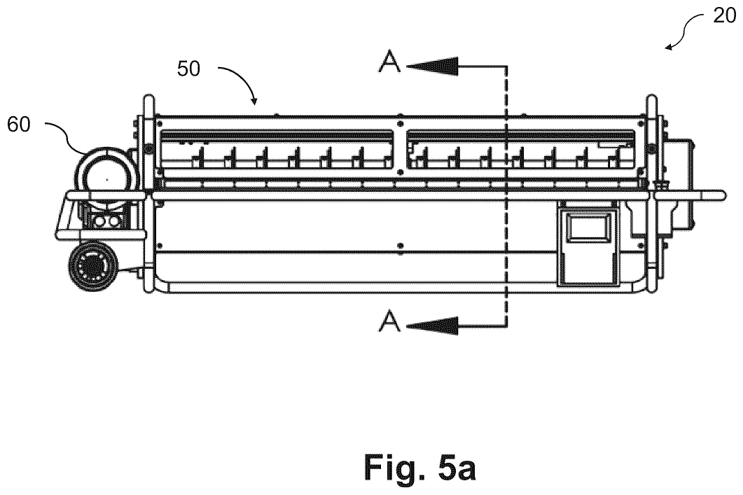

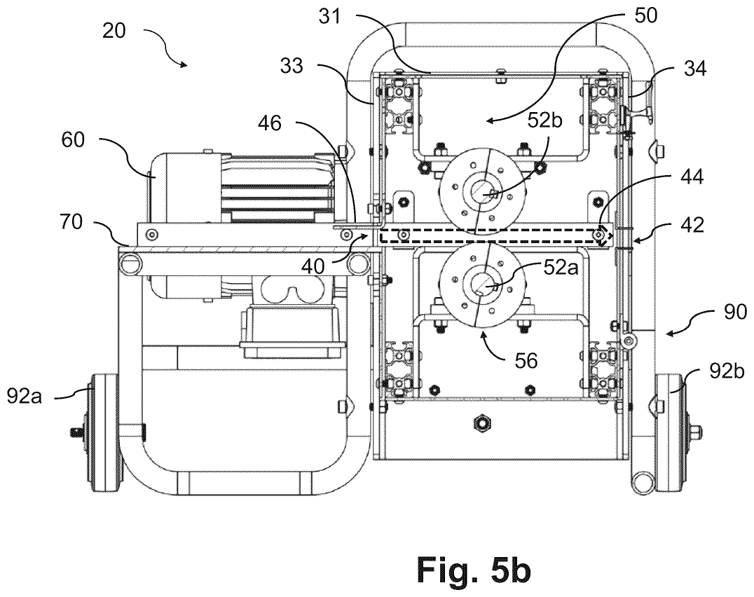

As illustrated in FIGS. 1 and 5b, the worktable 70 is adjacent to the article entrance 40 of the housing 30, upstream thereof. The worktable 70 at least partially supports the plate-shaped article 10 as it is being received in the article entrance 40. As illustrated in FIG. 3, a plate-shaped article 10 can be long comparatively to the housing 30, hence the utility of the worktable 70 to provide support to the article 10, adjacent to the article entrance 40. The surface of the worktable 70 can be levelled with the article entrance 40 of the housing 30 and can extend upstream therefrom. It is to be noted that the shape, the configuration, and the location of the worktable 70 can vary from the embodiment shown.

Additionally, as better shown in FIGS. 1 and 5b, the housing 30 can include a lip 46, which extends perpendicularly from the front wall 33 and outwardly thereof, so that the lip 46 extends substantially parallel to the worktable 70, but vertically spaced-apart therefrom. A distance between an upper surface of the worktable 70 and the lip 46 can correspond to a thickness of the plate-shaped article 10 inserted in the board cutting apparatus 20. The lip 46 may stabilize the plate-shaped article 10 during its introduction into the housing 30, by interfering with any undesirable upward motion of the article 10 that occurs during the cutting operation. It is to be noted that the shape, the configuration, and the location of the lip 46 can vary from the embodiment shown. Furthermore, it is appreciated that, in an embodiment, the lip 46 can be adjustable in height if the board cutting apparatus 20 is designed to receive plate-shaped articles 10 of different thicknesses.

### Carrier

Advantageously, in an embodiment, the board cutting apparatus 20 may comprise a carrier 90 onto which the housing 30 and the worktable 70 can be mounted, for carrying and displacing the cutting device 50 and its housing 30. It is to be understood that the carrier 90 can be a monolithic element or embodied by a plurality of assembled components. In some embodiments, the carrier 90 can also serve as a protective frame for the apparatus as will be discussed in more detail below.

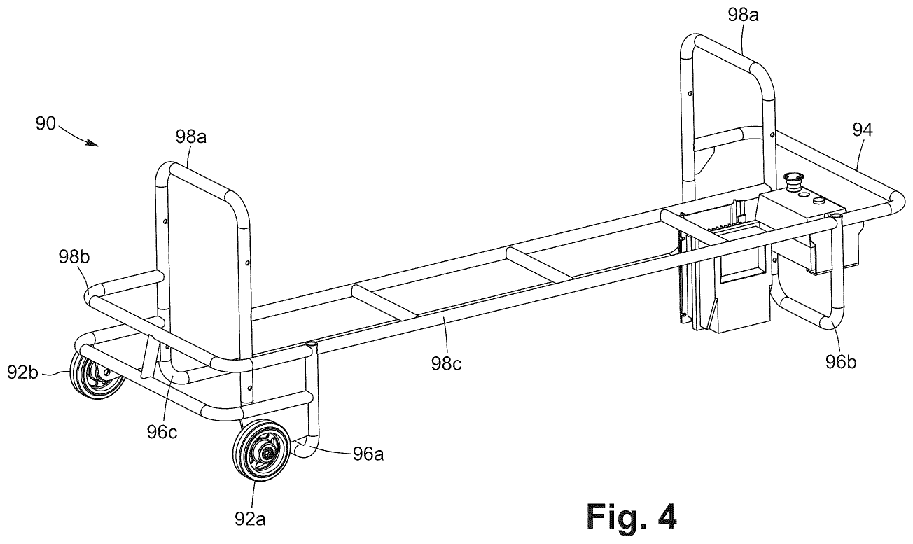

Referring now to the embodiment shown in FIGS. 1 to 5b, and more specifically to FIG. 4, the carrier 90 can be a modular tube frame (i.e., a tube chassis) which has the advantage of being relatively light weight and can require few parts to assemble. The carrier 90 shown is provided with legs 96a, 96b, 96c to support the cutting device 50 and wheels 92a, 92b to allow easy placement and movement of the apparatus. A handle 94 is also provided to facilitate handling of the carrier 90. With these elements, an operator can transport the cutting device 50 by lifting the carrier 90 by the handle 94 to roll the cutting device 50 and its housing 30 on its wheels 92a, 92b. In the embodiment shown, the motor 60 is mounted to the carrier 90 on one side thereof. It is to be noted that wheels 92a, 92b can be advantageously located on the same side as the motor 60 to distribute the load of the board cutting apparatus 20 more efficiently during transportation.

The carrier 90 shown in FIGS. 1 to 5b, and more particularly FIG. 4, also comprises a framing structure 98a for surrounding at least partially the housing 30, and thus protecting same, and also additional framing structures 98b, 98c for supporting the motor 60 and the worktable 70. With this implementation, if the board cutting apparatus 20 inadvertently rolls over, or otherwise tips from its normal standing position, or collides with a large foreign object, the carrier 90 can at least partially protect the cutting device 50.

The embodiment of the carrier 90 shown in the Figures is non-limitative. It is understood that alternative embodiments to protect the housing 30, the motor 60, and/or the worktable 70 can be foreseen. For instance and without being limitative, the carrier 90 implemented by a tube frame can alternatively be replaced, at least partially, with a chassis of a similar shape.

### Cutting Device

The cutting device 50 includes a rotating shaft 52 mounted in the housing 30 across the conveying path 44, i.e., the rotating shaft 52 extends normal to the conveying path 44. The embodiment shown in the drawings comprises two rotating shafts 52a, 52b (a first shaft 52a and an additional shaft 52b, also referred as the second shaft) mounted one above each other (see FIG. 5b). However, other embodiments not illustrated may include a single rotating shaft and also allow a plate-shaped article to be cut into multiple elongated slats. Each one of the cutting blade assemblies of the cutting device 50 includes at least one circular blade 560 mounted to the rotating shaft 52 to cut the plate-shaped article 10 and an adjustable blade mount 58 for each circular blade 560 mounted to the shaft 52. As shown in the embodiment of FIGS. 1 to 3, the cutting device 50 is at least partially confined in the housing 30.

### Rotating Shaft(s)

In the embodiment shown in FIGS. 1 to 3, the rotating shafts 52a, 52b are rotatably mounted in the housing 30 and, more particularly, mounted to the sidewalls 35a, 35b, such that they can freely rotate about their rotation axis. It is to be noted that the shape, the configuration, and the location of the rotating shafts 52a, 52b can vary from the embodiment shown.

As best shown in FIG. 5b, according to this embodiment, the additional or second rotating shaft 52b is configured to be spaced apart and parallel in relation with the first rotating shaft 52a, the first shaft 52a extending just below the conveying path 44 and the second shaft extending just above same.

In the embodiment shown, including two rotating shafts 52a, 52b with the conveying path 44 extending inbetween, the two rotating shafts 52a, 52b rotate in opposed rotation direction, i.e., a first one of the shafts rotates in the clockwise direction while a second one of the shafts rotates in the counterclockwise direction.

One end of one of the first rotating shaft 52a is operatively connected to the motor 60 to provide the required torque to the shaft 52a. In the embodiment shown, the motor 60 is located adjacent to the left of the housing 30 (i.e., adjacent to the left sidewall 35a). Alternatively, a plurality of motors 60 may be mounted adjacent to both side walls 35a, 35b such that both ends of the shaft 52a are rotatably connected to a respective motor 60. In an alternative embodiment, each one of the shafts 52a, 52b can be driven by its own motor 60.

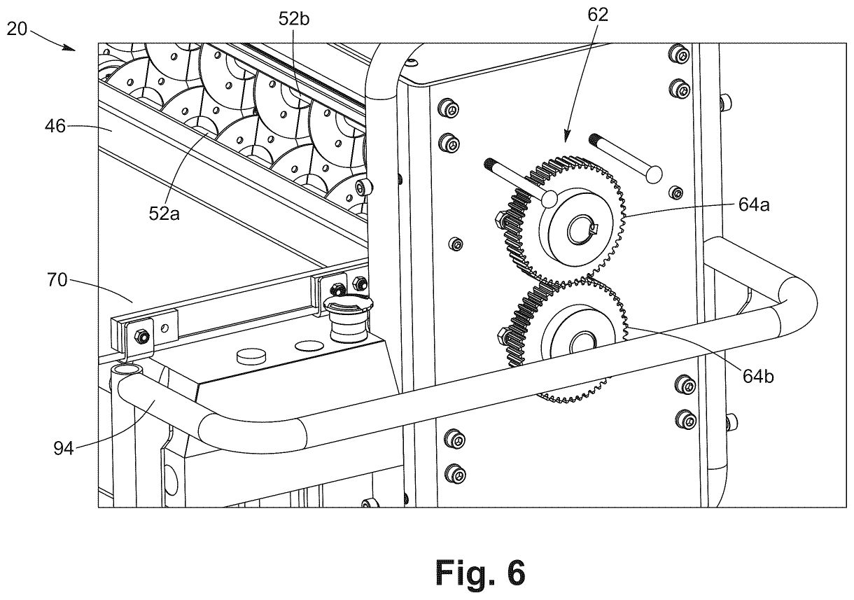

In the non-limitative embodiment shown, a gear assembly (or gearing) 62 is provided to operatively connect both shafts 52a, 52b and ultimately provide power to the shaft that is not directly driven by the motor 60, in this case the second shaft 52b. It is to be understood that the gear assembly 62 of the cutting device 50 is configured such that the shafts 52a, 52b rotate in opposing rotational directions. Consequently, when the plate-shaped article 10 reaches the conveying path 44, the plate-shaped article 10 is automatically entrained (or is at least substantially entrained, with minimal physical intervention from an operator) by the two rotating shafts 52a, 52b, and transported in and out of the housing 30, which can reduce the effort expanded by an operator and/or cut the article 10 more quickly. It is noted that the term “entrained” used herein is to be understood as the act to draw in and transport a plate-shaped article 10 along the conveying path 44. For instance, in the embodiment shown in FIG. 6, the gear assembly 62 can be implemented with two spur gears 64a, 64b, each connected to one of the rotating shafts 52a, 52b. It is to be noted that the shape, the configuration, and the location of the gear assembly 62 can vary from the embodiment shown. As a non-limiting example, the gear assembly 62 could be implemented inside or outside of the housing 30.

Referring to the embodiment shown in FIG. 5b, the two rotating shafts 52a, 52b can be fixed to additional attachments connected to the housing 30, to better secure and stabilize the shafts 52a, 52b during operation.

As described above, the motor 60 is operatively connected to the rotating shaft 52a to provide the required torque to cut the plate-shaped article 10. The motor 60 can be combined to a transmission system, such as a worm gearbox, to translate the torque provided by the motor 60 to the rotational shaft 52a at a desired speed. The motor 60 itself may be embodied by a 0.75 hp motor. The motor 60 can be entirely or partially electric (i.e., hybrid electric). To this end, the board cutting apparatus 20 can comprise a support drive 68 (e.g., a variable frequency drive and/or control setup) shown in FIGS. 1, 2, 5a and 5b. It is to be noted that the shape, the configuration, and the location of the motor 60 can vary from the embodiment shown.

### Circular Blade

At least one circular blade assembly 56 is used to cut the plate-shaped article 10 across the conveying path 44 of the housing 30. In the non-limitative embodiment shown, the cutting device 50 of the board cutting apparatus 20 includes a plurality of longitudinally spaced-apart blade assemblies 56 mounted to the rotating shafts 52a, 52b. Each one of the circular blade assemblies 56 includes a circular blade 560 and a blade mount 58. It is understood that the diameter of the circular blade 560 is such that the blade extends from the adjustable blade mount 58 enough to reach the conveying path 44 and cut through the article 10. The circular blade 560 can be made of any material suitable for cutting a provided article 10. It is envisioned by the present disclosure that several sets of circular blades 560 of varying characteristics (e.g., diameter, material, thickness and sharpness) can be provided so that an operator may interchange a set of circular blades 560 with another to operate the apparatus according to different specifications.

Referring to the embodiments shown in FIGS. 5b and 7, it is shown that the circular blades 560 can be two-pieces circular blades including two separable half-discs 562a, 562b, which can be fixed to their respective blade mount 58 without detaching/untightening the blade mount 58 from the rotating shaft 52, as will be described in more detail below. Referring specifically to the embodiment of FIG. 7, it is shown that blade mounting apertures 566a can be provided and evenly distributed along a circle around the center of the circular blade 560 to insert mechanical fasteners (intentionally not represented), such as screws, bolts, rivets, through the circular blade 560 blade to fix the blade 560 to a corresponding blade mount 58. However, the number, location and type of the fastener mounting apertures 566a and the fasteners can vary. As will be explained in detail below, the mounting apertures 566a can have corresponding blade mounting apertures 566b located on each blade mount 58. It is to be noted that the shape, the configuration, and the location of the circular blade 560 can vary from the embodiment of the two-piece blade 560 shown.

In the non-limitative embodiment shown, the cutting device 50 includes two rotating shaft 52a, 52b. In the embodiment shown, the circular blades 560 mounted to the two rotating shafts 52a, 52b are aligned with one another. However, in an alternative embodiment (not shown), the circular blades 560 mounted to the two rotating shafts 52a, 52b could not be aligned with one another.

### Adjustable Blade Mount

The adjustable blade mount 58 is mounted to the rotating shaft 52 and is configured to be detachably/removably mounted to the rotating shaft 52. It is also configured to be displaceable, such as slidable and/or translatable, along the rotating shaft 52 so as to easily and quickly adjust its longitudinal position along same. Each one of the blade mounts 58 is also configured to receive and support a respective one of the two-piece circular blade 560 as described above.

Thus, each one of the blade mounts 58 can be secured to the rotating shaft 52 at a first longitudinal position, detached from the rotating shaft 52, displaced along the rotating shaft 52 and secured to another longitudinal position along the shaft 52, spaced-apart from the first longitudinal position. Therefore, since a respective one of the circular blade 560 is mounted to the blade mount 58, the longitudinal position of the circular blade 560 is modified simultaneously. A width of the slats 12 cut into the article 10 can be adjusted in accordance with the user's needs by adjusting the longitudinal position(s) of the blade mount(s) 58 along the shaft(s) 52, as will be described in more details below.

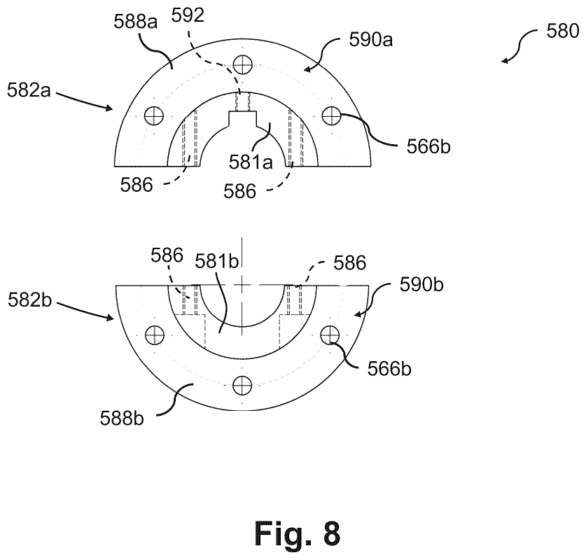

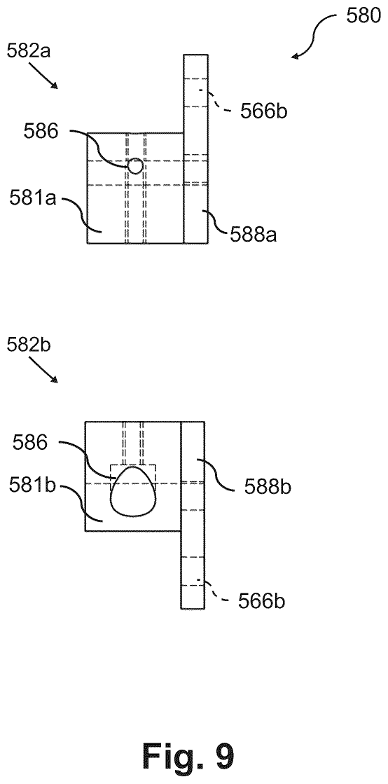

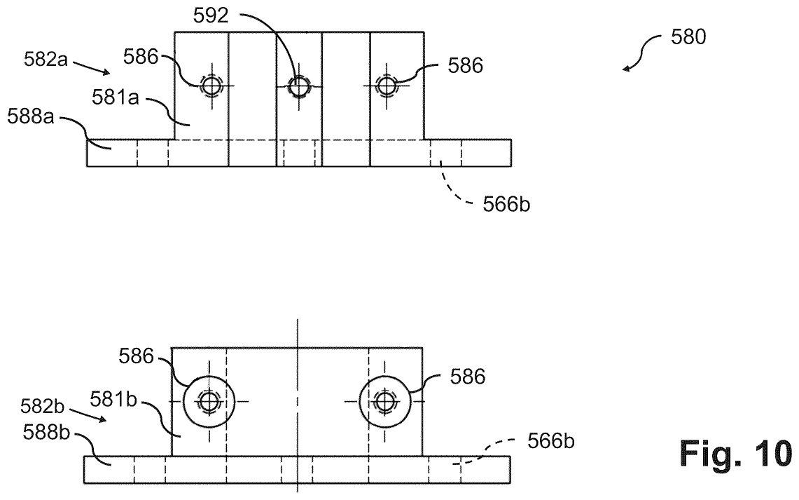

Referring to the embodiment illustrated in FIGS. 8 to 10, the blade mount 58 can include a two-piece collar 580 having separable first and second half collars 582a, 582b.

Each one of the half collars 582a, 582b includes an inner portion 581a, 581b and a support plate 588a, 588b protruding outwardly from the respective inner portion 581a, 581b. In the non-limitative embodiment shown, the inner portion 581a, 581b of each half collars 582a, 582b is characterized by a smaller diameter than a diameter of the support plate 588a, 588b. Each one of the support plates 588a, 588b circumscribes a corresponding one of the inner portions 581a, 581b. In the non-limitative embodiment shown, the inner portion 581a, 581b and the support plate 588a, 588b of one of the half collars 582a, 582b are a single piece. The inner portions 581a, 581b are configured to secure the two half collars 582a, 582b together while each one of the support plates 588a, 588b is configured to support a respective portion of the two-piece blade 560. Particularly, in the embodiment shown, each one of the support plates 588a, 588b has a cutting blade-receiving face 590a, 590b adapted to support at least a portion of a respective one of the half-discs 562a, 562b. More particularly, a portion of a respective one of the half-discs 562a, 562b is superposed to a respective one of the cutting blade-receiving face 590a, 590b when mounted thereto.

Thus, the first and second half collars 582a, 582b are configured to be fastened to one another, along and around the rotating shaft 52, with half collars securing means 586 (i.e., a half collars interlocking assembly 586). The half collar securing means 586 can be partially embodied by two parallel fastener-receiving channels defined in each of the half collars 582a, 582b, one on each side of the inner portion 581a, 581b of the half collars 582a, 582b. Thus, mechanical fastening elements (not shown), such as a screws and bolts, can be used to be removably inserted in the half collar securing means 586 to secure the half collars 582a, 582b of the two-piece collar 580 together.

In addition, the tolerance of the inner portions 581a, 581b of the two-piece collar 580 can be configured such that the adjustable blade mount 58 can be displaced along the rotating shaft 52 without difficulty when being repositioned to a desired position on the shaft 52. In other words, according to one non-limitative embodiment, when the fasteners inserted in the half collar securing means 586 or when a shaft locking assembly are untightened, the tolerance of the diameter of the inner portion 581a, 581b is sufficient to allow the blade mount 58 to be translated longitudinally along the rotating shaft 52 without substantial frictional interference with the shaft 52. More specifically, the adjustable blade mount 58 can be displaced, such as by translation, along the rotating shaft 52 without having to separate the two half collars 582a, 582b, provided that the blade mount 58 is unlocked from the rotating shaft 52, as detailed below. It is to be noted that the shape, the configuration, and the location of the two-piece collar 580 can vary from the embodiment shown.

Moreover, each first and second half collar 582a, 582b includes one of the support plates 588a, 588b extending perpendicularly to a longitudinal axis of the rotating shaft 52 when mounted thereto. Each support plate 588a, 588b includes blade mounting apertures 566b corresponding in number, compatibility, and relative location to the previously discussed mounting apertures 566a located on the two-piece circular blade 560, so that blade fasteners can be inserted into the aligned mounting apertures 566a, 566b to detachably secure the two-piece blade 560 to its adjustable blade mount 58. It is to be understood that the type of mechanical fasteners and the shape of the mounting apertures 566a, 566b used in the blade 560 and the support plates 588a, 588b can vary from one embodiment the next and that any mechanical fastener or attachments [fixture] suitable for fixing the blade 560 to its blade mount 58 is envisioned herein. For instance, the mounting apertures 566a, 566b may be hollow holes, so that a screw can be inserted therein to fix a bolt at the back of the support plates 588a 588b. Alternatively, the blade mounting apertures of the support plates 566a, 566b can be mounting apertures having a threaded inner wall configured to receive a screw inserted into the blade mounting apertures of the blade 560.

As previously mentioned, the adjustable blade mount 58 is configured to be displaceable and adjustable along the rotating shaft 52. The adjustability of the blade mount 58 is characterized by its ability to displace (e.g. translate when unsecured) a respective circular blade 560 along the rotating shaft 52, or to remove or add circular blade assemblies 56 altogether if fewer or more blades 560 are required to cut the article 10 into slats 12. To provide this flexibility, according to one embodiment, the adjustable blade mount 58 can include a detachable locking assembly 592 for locking the blade mount 58 at a determined longitudinal position along the rotating shaft 52. The shaft locking assembly 592 can conversely be untightened or unlocked to allow the translation/displacement, the addition or the removal of at least one of the circular blade assemblies 56 along the shaft 52.

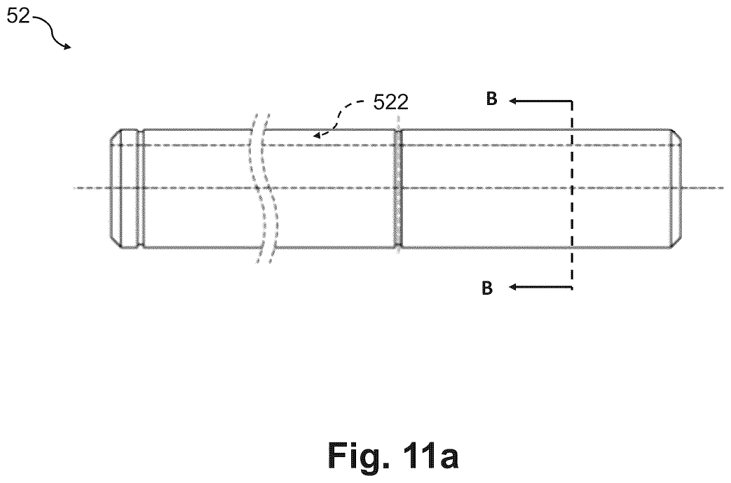

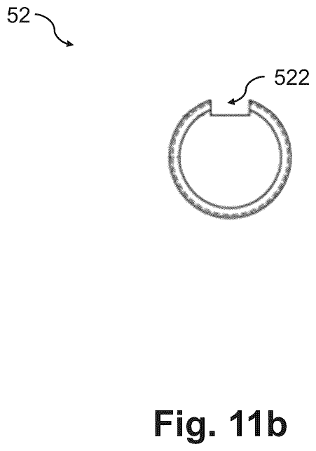

As illustrated in the embodiment of the adjustable blade mount 58 shown in FIGS. 8 to 10, the detachable locking assembly 592 can be embodied by a shaft locking channel defined in the first half collar 582a and a corresponding elongated groove 522 (i.e., the shaft locking groove) extending longitudinally along the rotating shaft 52 shown in FIG. 11a. The shaft locking channel 592 and the shaft locking groove 522 have substantially the same width and are substantially aligned when the blade mount 58 is secured to the shaft 52, so that a mechanical fastener, such as a screw, for instance, can be inserted and fixedly locked into the shaft locking groove 522, such that the blade mount 58 is secured to the shaft 52 at a predetermined longitudinal position. It is to be understood that the locking groove 522 at least partially prevents the adjustable blade mount 58 from rotating about and sliding along the shaft 52, which could hinder the proper rotation of the corresponding circular blade 560.

According to another aspect of this disclosure, the implementation of the detachable shaft locking assembly 592 described here above can also be implemented to an adjustable blade mount 58 that includes a monolithic collar (i.e., an adjustable blade mount 58 without separable pieces) configured to be loosened so as to displace the blade mount 58 along the shaft 52 and tightened at a desired longitudinal position thereto without entirely dismantling the blade mount 58. It is to be noted that the shape, the configuration, and the location of the detachable locking means 592 to detachably secure the blade mounts 58 to the shaft 52 can vary from the embodiment shown.

In use, an operator wishing to cut a plate-shaped article 10, such as a gypsum/drywall sheet, into two or more slats of a predetermined/selected width is required to first select the number and longitudinal position(s) of circular blades 560 along the shaft. Then, the operator positions and secures a corresponding number of adjustable blade mounts 58 on the rotating shaft(s) 52. The circular blades 560, such as the half-discs 562a, 562b can be secured to the respective blade mount 58 when the latter is secured to the shaft 52. For instance, referring to the illustration of FIG. 3, to cut fifteen slats 12 out of a plate-shaped article 10 which has a maximum width that can be received by the article entrance 40 of the housing 30, an operator can secure fourteen adjustable blade mounts 58 mounted with their respective circular blade 560 in series along the rotating shaft(s) 52, all equidistant from each other. How an adjustable blade mount 58 is mounted to the rotating shaft 52 depends on the embodiment. For instance, if the adjustable blade mount 58 includes the two-piece collar 580 and is fixed to the two-piece blade 560, the detachable shaft locking assembly 592 can be adjusted to remove, add or translate the two-piece collar 580 along the rotating shaft 52 to the desired longitudinal position, all without detaching the half-discs 562a, 562b from their respective blade mounts 58. Also, additional circular blades 560 can be added to increase the number of slats 12 cut simultaneously. Alternatively, if the two-piece circular blade 560 is provided, its half-discs 562a, 562b can be detached and removed directly from the adjustable blade mount 58 without untightening the detachable shaft locking assembly 592 securing the blade mount 58 to the rotating shaft 52.

Once the desired number of circular blades 560 is mounted in an equidistant or irregular configuration along the rotating shaft 52, the motor 60 of the cutting device 50 can be activated. For better control and safety, it is expected that the operator stands in front of the worktable 70 to gradually insert (e.g., push and slide) the plate-shaped article 10 into the cutting device 50. Then, the article 10 can be gradually inserted into the article entrance 40 of the housing 30 at a desired speed as it is being supported by the worktable 70 and its vertical displacement is limited by the lip 46. As the article 10 moves through the conveying path 44 of the housing 30, the article 10 meets the rotating circular blades 560, which cut the article 10 into slats 12. If the cutting device 50 includes two rotating shafts 52a, 52b as previously described, the article 10 can be automatically entrained into the conveying path 44 when it reaches the cutting device 50. Regardless of the embodiment of the cutting device 50, the slats 12 leave the housing 30 through the slat exit 42 wherefrom they can be recovered.

As disclosed above, the blade mounts 58 are adjustable along the shaft 52. Therefore, the position of the circular blade assemblies 56 along the rotating shaft(s) 52 can be easily adjusted depending on the cutting specifications. The board cutting apparatus 20 can be used to cut a plate-shaped article 10 (e.g., sheet, plate, or board) and obtain slats 12 to the desired specifications (e.g., desired width(s) of slats). Depending on the desired configuration, an operator may cut an article 10 into as few as two slats, or into as many slats as the maximum number of blade mounts 58 that can be mounted to its rotating shaft 52 (or plurality hereof). Consequently, the board cutting apparatus 20 can offer a wide range of configurations to modulate the size and number of the slats 12 that can be produced simultaneously. The above disclosure provides implementations of the blade mount 58 and the circular blade 560 mounted to the blade mount 58 designed to be adjustable along the rotating shaft 52. In some configurations, a plurality of circular blade assemblies 56 can be provided in series along the rotating shaft(s) 52 to cut the article 10 into a relatively large number of slats 12 by a single continuous operation. According to some embodiments wherein the board cutting apparatus 20 includes a plurality of rotating shafts 52, the cutting device 50 can be configured to entrain (i.e., to draw in and transport) the plate-shaped article 10 in and out of the housing 30 along the conveying path 44. Moreover, in some embodiments, a housing/cutting device carrier 90 can provided to facilitate the transport thereof.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited by the scope of the appended claims.

1. A board cutting apparatus for cutting a plate-shaped article into slats, comprising:
a housing having a plate-shaped article entrance, a slat exit, and a conveying path extending between the plate-shaped article entrance and the slat exit; and
a cutting device at least partially located in the housing across the conveying path, the cutting device comprising:
a rotating shaft;
at least one adjustable blade mount mounted to the rotating shaft and configured to be displaceable along the rotating shaft; and
at least one circular blade secured to a respective one of the at least one adjustable blade mount and being engaged in rotation with the rotating shaft.

2. The board cutting apparatus of claim 1, further comprising:
a worktable extending upstream of the plate-shaped article entrance of the housing and configured to support the plate-shaped article as the plate-shaped article is received in the housing via the plate-shaped article entrance.

3. The board cutting apparatus of claim 2, wherein the housing further having a lip adjacent to the plate-shaped article entrance and extending substantially parallel to the worktable and vertically spaced-apart therefrom, the lip being configured to stabilize the plate-shaped article during introduction of the plate-shaped article into the housing.

4. The board cutting apparatus of claim 1, wherein the cutting device further comprises:
an additional rotating shaft mounted in a spaced apart and parallel configuration with the rotating shaft with a section of the conveying path extending inbetween;
a motor operatively connected to the rotating shaft and the additional rotating shaft; and
a gear assembly mechanically connecting together the rotating shaft and the additional rotating shaft to rotate in opposing rotational directions whereby when the plate-shaped article reaches the cutting device, the plate-shaped article is automatically entrained between the rotating shaft and the additional rotating shaft to be cut into slats.

5. The board cutting apparatus of claim 1, wherein:
each one of the at least one circular blade comprises a first half-disc and a second half-disc; and
each one of the at least one adjustable blade mount comprises:
a first half collar and a second half collar, each one of the first and second half collars comprising an inner portion engageable with the rotating shaft and a support plate protruding outwardly from and extending perpendicularly to a longitudinal axis of the rotating shaft when mounted thereto; and
wherein the cutting device further comprises mechanical fasteners engageable with a respective one of the first and second half-discs and a respective one of the first and second half collars to secure the first and second half-discs to the respective one of the first and second half collars.

6. The board cutting apparatus of claim 5, wherein the at least one adjustable blade mount further comprises a shaft locking assembly for detachably securing the first and second half collars at a selected longitudinal position along the rotating shaft.

7. The board cutting apparatus of claim 1, further comprising:
a carrier on which the housing and the cutting device are mountable for carrying and displacing same.

8. The board cutting apparatus of claim 7, wherein the carrier comprises one or more framing structures surrounding at least partially the housing and the cutting device and protecting same.

9. An adjustable blade mount for a rotating shaft of a board cutting apparatus, comprising:
a first half collar and a second half collar engageable with the rotating shaft of the board cutting apparatus;
each one of the first and second half collars comprising an inner portion superposable against the rotating shaft and a support plate protruding outwardly from the inner portion and extending perpendicularly to a longitudinal axis of the rotating shaft when mounted thereto, and each support plate having a cutting blade-receiving face configured to support at least a portion of a circular cutting blade having respective first and second half-discs; and
mechanical fasteners engageable with a respective one of the first and second half-discs and the cutting blade-receiving face of the support plate of a respective one of the first and second half collars to secure the first and second half-discs to the respective one of the first and second half collars.

10. The adjustable blade mount of claim 9, further comprising:
a shaft locking assembly configured to detachably secure the first and second half collars at a selected longitudinal position along the rotating shaft.

11. A board cutting apparatus for cutting a plate-shaped article into slats, comprising:
a housing defining a plate-shaped article entrance for receiving the plate-shaped article, a slat exit opposite of the plate-shaped article entrance to expel the slats, and a conveying path extending between the plate-shaped article entrance and the slat exit; and
a cutting device including at least one rotating shaft at least partially located in the housing and across the conveying path, and at least one cutting blade assembly mounted to the at least one rotating shaft, engageable in rotation therewith, and securable thereto in at least two longitudinally spaced-apart positions.

12. The board cutting apparatus of claim 11, wherein each one of the at least one cutting blade assembly comprises at least one adjustable blade mount detachably securable to the at least one rotating shaft and configured to be displaceable along the least one rotating shaft; and at least one circular blade detachably secured to a respective one of the at least one adjustable blade mount and being engaged in rotation with the at least one rotating shaft when the at least one blade mount is secured thereto.

13. The board cutting apparatus of claim 11, further comprising:
a worktable extending upstream of the plate-shaped article entrance of the housing and configured to support the plate-shaped article as it is received in the housing via the plate-shaped article entrance.

14. The board cutting apparatus of claim 13, wherein the housing further comprises a lip adjacent to the plate-shaped article entrance and extending substantially parallel to the worktable and vertically spaced-apart therefrom, the lip being configured to stabilize the plate-shaped article during introduction of the plate-shaped article into the housing.

15. The board cutting apparatus of claim 11, wherein the cutting device further includes:
an additional rotating shaft mounted in a spaced apart and parallel configuration with the rotating shaft with a section of the conveying path extending inbetween;
a motor operatively connected to the rotating shaft and the additional rotating shaft; and
a gear assembly mechanically connecting together the rotating shaft and the additional rotating shaft to rotate in opposing rotational directions whereby when the plate-shaped article reaches the cutting device, the plate-shaped article is automatically entrained between the rotating shaft and the additional rotating shaft to be cut into slats.

16. The board cutting apparatus of claim 12, wherein:
each one of the at least one circular blade comprises a first half-disc and a second half-disc; and
each one of the at least one adjustable blade mount comprises:
a first half collar and a second half collar, each one of the first and second half collars comprising an inner portion engageable with the rotating shaft and a support plate protruding outwardly from and extending perpendicularly to a longitudinal axis of the rotating shaft when mounted thereto; and
wherein the at least one cutting blade assembly further comprises mechanical fasteners engageable with a respective one of the first and second half-discs and a respective one of the first and second half collars to secure the first and second half-discs to the respective one of the first and second half collars.

17. A method for cutting a plate-shaped article into slats having predetermined widths, the method comprising:
adjusting a longitudinal position of at least one cutting blade assembly along a rotating shaft of a cutting device in accordance with the predetermined width of the slats;
securing the at least one cutting blade assembly at the longitudinal position;
engaging the rotating shaft having the at least one cutting blade assembly secured thereto in rotation; and
translating the plate-shaped article along a conveying path to engage the at least one cutting blade assembly and be cut into the predetermined width slats.

18. The method of claim 17, wherein the at least one cutting blade assembly comprises at least two cutting blade assemblies, and wherein the adjusting of the respective longitudinal position of the at least one cutting blade along the rotating shaft in accordance with the predetermined width of the slats further comprises distributing the at least two cutting blade assemblies according to an irregular configuration wherein a distance between adjacent ones the at least two cutting blade assemblies is variable.

19. The method of claim 17, further comprising:
at least one of adding and removing a respective one of the at least two cutting blade assemblies to the rotating shaft.

20. The method of claim 17, wherein the adjusting of the respective longitudinal position of the at least one cutting blade assembly along the rotating shaft in accordance with the predetermined width of the slats further comprises selectively untightening a shaft locking assembly of the at least one cutting blade assembly and sliding the at least one cutting blade assembly along the rotating shaft, and wherein securing the at least one cutting blade assembly at the longitudinal position comprises tightening the shaft locking assembly of the at least one cutting blade assembly with the rotating shaft.
